(19) United States
(12) Patent Application Publication
(10) Pub. No.: US 2011/0130962 A1
(43) Pub. Date: Jun. 2, 2011

(54) Navigation system for delivery vehicles

(76) Inventor: Larry Damell Lindsey, Belden, MS (US)

(21) Appl. No.: 12/592,704

(22) Filed: Dec. 2, 2009

(51) Int. Cl. G01C 21/36

(52) U.S. Cl. 701/209

(57) ABSTRACT

A onboard navigation system for delivery vehicles used in conjunction with the GPS system to facilitate the delivery process with daily delivery route instructions, directions, and updates includes a navigation device mounted to the vehicle's dashboard and which includes a touch screen divided into a map display screen portion and a message display screen portion, operational and functional buttons, and electrical components that allow for the interchange and exchange of instructions, data, and information with the delivery driver's PDA so that the driver can download all the instructions, data, and information pertaining to that day's delivery schedule.

### FIELD OF THE INVENTION

The present invention pertains to navigation systems, and more particularly pertains to navigation systems for delivery vehicles and their drivers to facilitate the delivery process.

### BACKGROUND OF THE INVENTION

Delivery, cargo, and supply vehicles of all types are under daily pressure to deliver their numerous goods to their destinations on time and with no delays. The pressures have intensified due to a number of factors, including but not limited to: increased traffic on streets, roads, and highways that delays and slows down deliveries; constant construction that not only slows down and delays deliveries but forces the rerouting of the delivery vehicles; increased vehicle maintenance costs which necessitates that drivers find the quickest and most efficient routes; and increased fuel costs that demand that drivers of all types of delivery vehicles located the most efficient routes to make their daily deliveries.

Thus, it is highly desirable to have available means or methods that delivery drivers can utilize to locate the most efficient routes for making their daily deliveries. While maps still have their place for general directions, the GPS system used in conjunction with the various consumer-oriented GPS navigational systems has largely rendered maps obsolete. GPS systems are generally pre-loaded with directions, and then the owners receive periodic map updates. However, as delivery routes change from day to day, it is imperative that the drivers have up-to-date maps available on a daily basis, and ideally the deliver routes should be loaded into the GPS and/or navigational system at the start of the delivery day with the deliver routes capable of being changed and updated prior to each workday.

The following patents disclose a range of navigational systems, methods, and devices.

For example, the Lee et al. patent (U.S. Pat. No. 7,197,392 B2) discloses a method for detecting a map matching position of a vehicle in a navigation system and which incorporates a GPS receiver.

The Sumizawa et al. patent (U.S. Pat. No. 7,231,297 B2) discloses a navigation system for guiding a vehicle to a destination by displaying an arrow on a display monitor indicating the direction of the next turn to be taken.

The Ruschkowski patent (U.S. Pat. No. 7,280,913 B2) discloses a motor vehicle navigation device that includes notification text broadcast via a loudspeaker information pertaining to the distance traveled by the vehicle.

The Uyecki patent (U.S. Pat. No. 7,289,904 B2) discloses a vehicle information system that receives traffic information including traffic flow and traffic incident information wherein the exchange is between a remote location and the vehicle.

The Spencer et al. patent (U.S. Pat. No. 7,295,921 B2) discloses a portable navigation system that includes a display, a keypad, a cpu, a map database and motion and position sensors.

The Kobayashi et al. patent (U.S. Pat. No. 7,302,342 B2) discloses an in-vehicle navigation apparatus for directing traffic to a second one-way traffic road when a first one-way traffic road becomes impassable.

The Kim patent (U.S. Pat. No. 7,349,801 B2) discloses a vehicle navigation system and method for guiding the path of a complex intersection more accurately.

The Takahashi et al. patent (U.S. Pat. No. 7,353,111 B2) discloses a navigation system that performs route guidance by taking the driver's personal feelings into account.

The Nakaishi et al. patent (U.S. Pat. No. 7,366,607 B2) discloses a navigation system that guides a vehicle from preset route information.

Nonetheless, despite the ingenuity of the above systems, methods, and devices, there remains a need for a simple, easy-to-use navigation system for delivery vehicles that is integrated with the delivery vehicle's onboard computer system.

### SUMMARY OF THE INVENTION

The present invention comprehends a navigation system for a delivery vehicle, such as a standard food delivery truck or UPS or FedEx delivery truck, which is similar to a standard GPS navigation system. The navigation system of the present invention allows the driver to download all of that day's delivery stops thereby providing for step-by-step driving instructions throughout the day, and interacts with the GPS system and the driver's PDA for receiving data and information in real time.

The navigation system of the present invention includes a touch display screen having a map display screen portion and a smaller message display screen portion. The touch display screen will preferably be mounted on the dashboard and to the right of the vehicle's steering wheel, and on the left side of the touch display screen are various function and operational buttons such as left and right map screen scroll buttons and an options buttons which brings up various options and functions on both the map display screen portion and the message display screen portion. The navigation system is battery powered with a battery life of at least 8 to 10 hours, and the navigation system has electrical components that allow the navigation system to communicate with and receive data, instructions, and information from the driver's PDA.

It is an objective of the present invention to provide a navigation system for delivery vehicles that is integrated with the vehicle's onboard computer system.

It is another objective of the present invention to provide a navigation system for delivery vehicles that is linked to the delivery vehicle's route.

It is yet another objective of the present invention to provide a navigation system for delivery vehicles wherein the navigation system automatically displays the delivery vehicle's next route, destination, and stop.

It is still yet another objective of the present invention to provide a navigation system for delivery vehicles that eliminates the need for a traditional paper map.

It is still yet a further objective of the present invention to provide a navigation system for delivery vehicles that allows the driver to download all of the day's stops for step-by-step driving instructions throughout the day.

Still another objective of the present invention is to provide a navigation system for delivery vehicles that allows the driver to complete his/her daily deliveries in the most efficient, cost and gas friendly manner possible.

Still yet another objective of the present invention is to provide a navigation system for delivery vehicles that is especially useful and helpful for drivers traversing unfamiliar terrain, locales, zip codes, areas, etc.

Still yet a further objective of the present invention is to provide a navigation system for delivery vehicles that assists the driver in finding the most efficient delivery and travel route.

A further objective of the present invention is to provide a navigation system for delivery vehicles that is easy to use and facilitates the location of miss-marked or missing addresses.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a side elevational view of the navigation system of the present invention illustrating the interconnection of the navigation system with the delivery vehicle and the driver's handheld PDA;

FIG. 2 is a perspective view of the navigation system of the present invention illustrating the location of the navigation system on the dashboard of the delivery vehicle;

FIG. 3 is a schematic representational view of the navigation system of the present invention illustrating the hardwired interconnection of the driver's PDA with the onboard navigation system;

FIG. 4 is a schematic representational view of the navigation system of the present invention illustrating the wireless interconnection of the driver's PDA with the onboard navigation system;

FIG. 5 is a representational flowchart of the navigation system of the present invention illustrating the sequence of steps that the navigation system undergoes during the delivery process; and

FIG. 6 is schematic representational view of the navigation system of the present invention illustrating the primary electrical components of the system.

### DETAILED DESCRIPTION OF THE PREFERRED EMBODIMENT

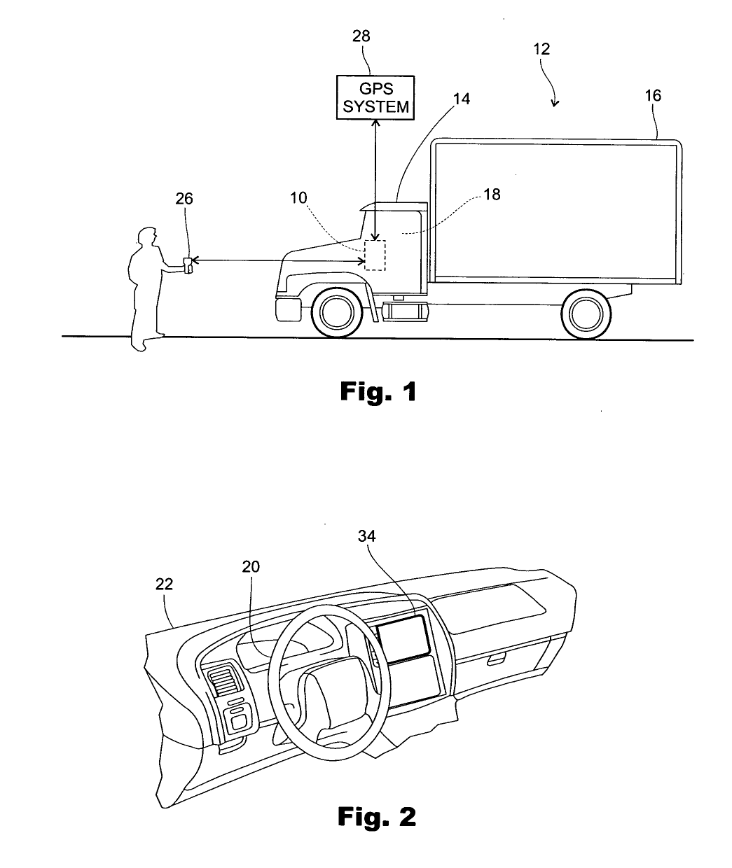

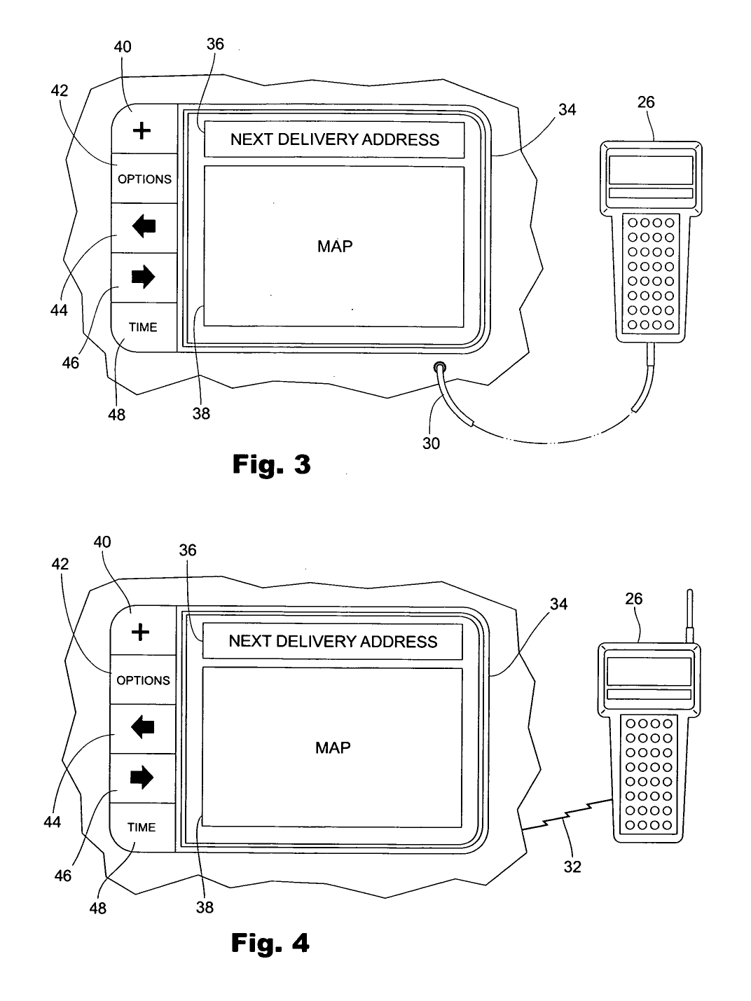

Illustrated in FIGS. 1-6 is navigation system 10 for a delivery vehicle such as a food delivery vehicle, a parts supply vehicle, a moving and storage vehicle or a UPS or FedEx vehicle. The representative delivery vehicle 12 includes a cab 14, a container section 16, and the cab 14 further defines an interior 18 having seats, a steering wheel 20 and a dashboard 22. The delivery vehicle 12 may have an onboard computer 24 already installed to which the navigation system 10 of the present invention communicates and is interconnected, and the driver is supplied with a portable, handheld PDA 26. The navigation system 10 of the present invention communicates with the 24/7/365 global communication network referred to as the GPS system 28, and receives instructions, data, and information pertaining to daily and up-to-date delivery routes and stops and allows the driver to download all the driving and delivery route instructions and locations for each day's delivery stops. It should be noted that while the navigation system 10 is primarily intended for delivery vehicles 12, it could be adapted for such uses as medical courier vehicles, newspaper delivery vehicles, fast food delivery vehicles, etc. FIG. 3 illustrates the PDA 28 being physically electrically connected to the navigation system 10 via an electrical cord 30 while FIG. 4 illustrates the PDA 26 communicating with the navigation system 10 via a wireless connection 32.

The navigation system 10 of the present invention, as shown in FIGS. 1-6, includes a touch display screen 34 mounted on and to the dashboard 22 and to the right of the steering wheel 20, and the touch display screen 34 (preferably an LCD-type screen) is further defined by an upper and smaller message display screen portion 36 and a larger map display screen portion 38. The visual image of the daily delivery route appears on the map display screen portion 38. Located to the left of the touch display screen 34 is a panel of operational and functional control buttons. A display enlargement button 40 with the + sign enlarges the visual image of the delivery route when pressed, and below this button 40 in succession is an options button 42 that lists all the options available to the driver, a left arrow screen scroll button 44 that scrolls the image—the delivery route and/or stops—on the map display screen 38 to the left, and right arrow screen scroll button 46 that scrolls the images on the map display screen 38 to the right, and a time button 48 that when pressed gives the tentative and prospective times for various events such as the times for making each delivery for that day's delivery stops.

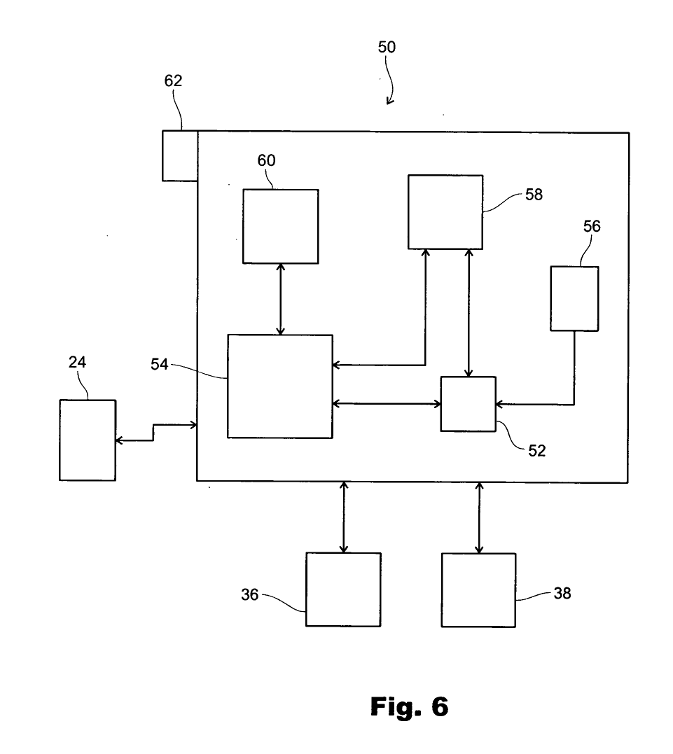

FIG. 6 illustrates a representative schematic 50 for the layout and interconnections of the electrical components of the navigation system 10. The conventional electrical components for the navigation system include a microprocessor 52, a memory unit 54, such as a flash memory, an antenna 56 for receiving instructions, data and information from the GPS system 28 and for communicating with the PDA 26, a battery 58 which has a working life of at least 8-10 hours before recharging, an operational and functional button interface board or component 60 that serves as the interface for the manually operable buttons 40-48 on the touch display screen 34, and an external plug 62 for the electrical cord 30 for connection to the PDA 26.

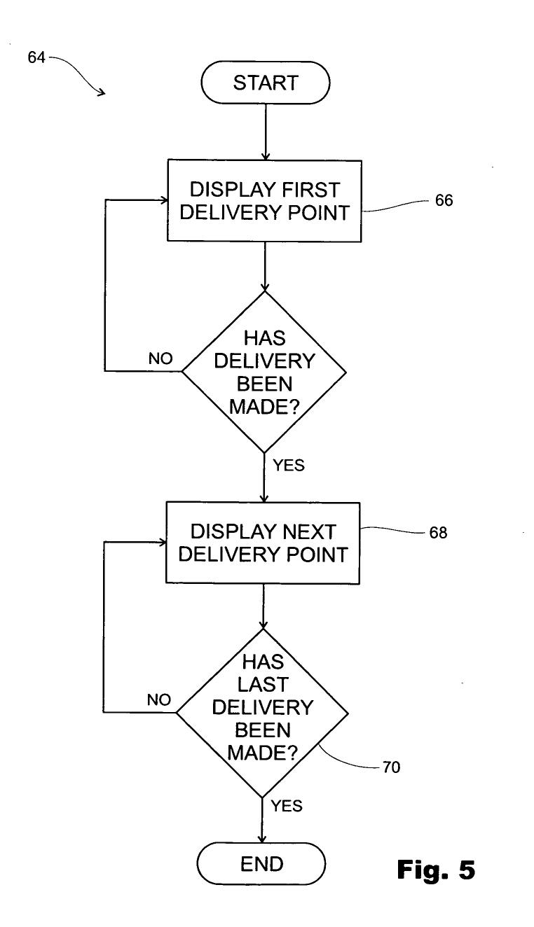

FIG. 5 illustrates a representative flowchart 64 for the navigation system 10 showing the sequence of steps that the delivery driver goes through in making his/her daily stops and deliveries. First, the navigation system 10 is started and the “Display First Delivery Point” 66 appears on the message display screen portion 36. If the delivery stop has been made the system goes to “Display Next Delivery Point” 68 message. If the delivery stop has not been made the “Display First Delivery Point” 66 stays on the screen 34 until, of course, that delivery stop has been made. The delivery driver proceeds through his/her sequence of delivery stops until the message “Has Last Delivery Been Made” 70 appears on the touch display screen 34. If this message appears then the driver has made all the stops and is done for the day; if this message hasn't yet appeared, then there are still more delivery stops to be made. Throughout the day the navigation system 10 will be in continuous contact with the GPS system 28 receiving delivery stop updates, additions, and, in some cases, deletions so that the driver is kept continually up-to-date on his/her delivery schedule.

A preferred embodiment of the invention has been disclosed herein, and it should be understood that numerous modifications, alterations, and variations are possible and practicable to those skilled in the art while still coming within the ambit and spirit of the invention and the scope of the invention as set forth by the appended claims.

I claim:

1. A navigation system for a delivery vehicle that communicates and operates in conjunction with the global GPS system and the delivery driver's PDA, comprising:
a touch display screen mounted to the dashboard of the delivery vehicle and having a message display screen portion and a map display screen portion;
a plurality of operational and functional buttons including a display enlargement button, an options button, a right arrow scroll button, a left arrow scroll button, and a time button;
a plurality of electrical components interconnected to the touch display screen and the operational and functional buttons including a microprocessor, a memory unit, and a battery; and
whereupon the delivery driver can download to the navigation system the list of delivery routes and stops from the GPS system so that the delivery driver has a list of sequential steps and instructions for driving and delivery routes that are accessible from the touch display screen so that the delivery driver can efficiently complete all of the day's deliveries and stops.

2. The navigation system for a delivery vehicle of claim 1 wherein the navigation system communicates with the PDA by a wireless connection.

3. The navigation system for a delivery vehicle of claim 2 wherein the navigation system communicates with the PDA by an electrical cord that physically interconnects the PDA to the navigation system.
